(19) United States
(12) Patent Application Publication
(10) Pub. No.: US 2012/0262366 A1
(43) Pub. Date: Oct. 18, 2012

(54) ELECTRONIC SYSTEMS WITH TOUCH FREE INPUT DEVICES AND ASSOCIATED METHODS

(75) Inventors: Yanning Zhu, Snoqualmie, WA (US); Aleksey Fadeev, Seattle, WA (US)

(73) Assignee: INGEONIX CORPORATION, Snoqualmie, WA (US)

(21) Appl. No.: 13/342,554

(22) Filed: Jan. 3, 2012

Related U.S. Application Data
(60) Provisional application No. 61/517,159, filed on Apr. 15, 2011.

(51) Int. Cl. G09G 5/00

(52) U.S. Cl. 345/156

(57) ABSTRACT

Embodiments of electronic systems, devices, and associated methods of operation are described herein. In one embodiment, a computing system includes an input module configured to acquire images of an input device from a camera, the input device having a plurality of markers. The computing system also includes a sensing module configured to identify segments in the individual acquired images corresponding to the markers. The computing system further includes a calculation module configured to form a temporal trajectory of the input device based on the identified segments and an analysis module configured to correlate the formed temporal trajectory with a computing command.

### CROSS-REFERENCE TO RELATED APPLICATION(S)

This application claims priority to U.S. Provisional Application No. 61/517,159, filed on Apr. 15, 2011.

### BACKGROUND

Input devices supply data and/or control signals to computers, television sets, game consoles, and other types of electronic devices. Over the years, input devices have evolved considerably from the early days of computers. For example, early computers used punched card readers to read data from punched paper tapes or films. As a result, generating even a simple input was quite burdensome. Recently, mice, touchpads, joysticks, motion sensing game controllers, and other types of “modern” input devices have been developed with improved input efficiencies.

Even though input devices have evolved considerably, conventional input devices still do not provide a natural mechanism for operating electronic devices. For example, mice are widely used as pointing devices for operating computers. However, a user must mentally translate planar two-dimensional movements of a mouse into those of a cursor on a computer display. Touchpads on laptop computers can be even more difficult to operate than mice because of variations in touch sensitivity and/or limited operating surfaces. In addition, operating conventional input devices typically requires rigid postures that can cause discomfort or even illness in users.

### BRIEF DESCRIPTION OF THE DRAWINGS

FIG. 1 is a schematic diagram of an electronic system in accordance with embodiments of the present technology.

FIG. 2A is a side cross-sectional view of an input device suitable for use in the system of FIG. 1 in accordance with embodiments of the present technology.

FIG. 2B is a front view of the input device of FIG. 2A.

FIGS. 2C and 2D are front views of additional embodiments of an input device in accordance with the present technology.

FIG. 2E is a side cross-sectional view of an input device in accordance with further embodiments of the present technology.

FIG. 3 is an electrical circuit diagram for the input device of FIG. 2A in accordance with embodiments of the present technology.

FIG. 4 is a block diagram showing computing system software modules suitable for the system of FIG. 1 in accordance with embodiments of the present technology.

FIG. 5 is a block diagram showing software routines suitable for the process module of FIG. 4 in accordance with embodiments of the present technology.

FIG. 6A is a flowchart showing a method of data input in accordance with embodiments of the present technology.

FIG. 6B is a flowchart showing a data processing operation suitable for the method of FIG. 6A in accordance with embodiments of the present technology.

FIG. 7A is a schematic spatial diagram showing an input device and a detector in accordance with embodiments of the present technology.

FIG. 7B is a schematic diagram illustrating a segmented image of the input device in FIG. 7A in accordance with embodiments of the present technology.

FIGS. 8A-8C schematically illustrate relative orientation between an input device and a detector in accordance with embodiments of the technology.

FIGS. 8D-8F schematically illustrate segmented images of the input device in FIGS. 8A-8C, respectively.

FIG. 8G schematically illustrates an input device plane relative to a detector plane in accordance with embodiments of the technology.

FIGS. 9A-9D schematically show one example of identifying a user action in accordance with embodiments of the present technology

FIG. 10 is a top view of a user's hand with multiple markers in accordance with embodiments of the present technology.

### DETAILED DESCRIPTION

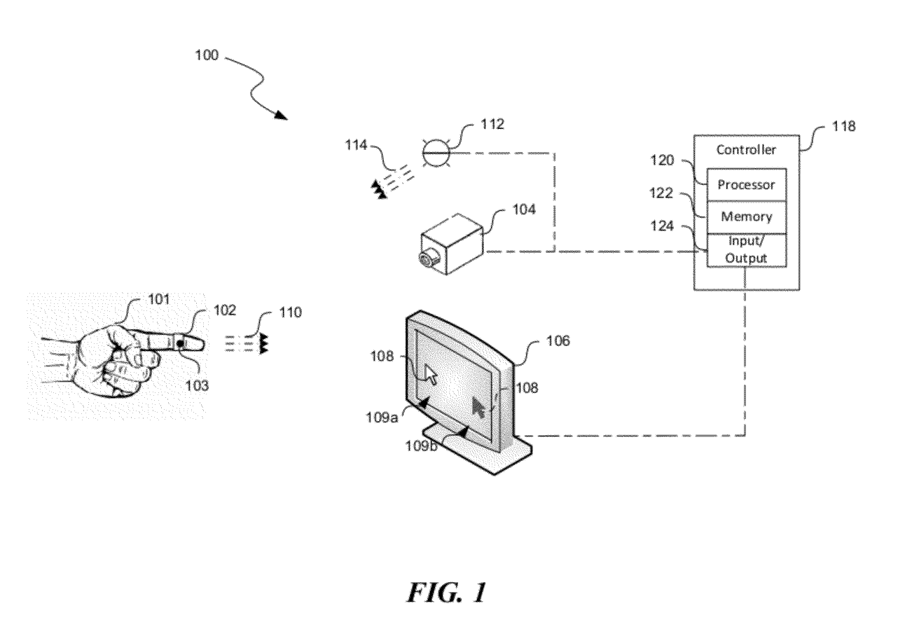

Various embodiments of electronic systems, devices, and associated methods of operation are described below. The term “marker” is used throughout to refer to a component useful for indicating, identifying, and/or otherwise distinguishing at least a portion of an object carrying and/or otherwise associated therewith. The term “detector” is used throughout to refer to a component useful for monitoring, identifying, and/or otherwise recognizing a marker. Examples of markers and detectors are described below with particular configurations, components, and/or functions for illustration purposes. The term “temporal trajectory” generally refers to a spatial trajectory of an object over time. The spatial trajectory can be in a two- or three-dimension space. Other embodiments of markers and/or detectors in accordance with the present technology may also have other suitable configurations, components, and/or functions. A person skilled in the relevant art will also understand that the technology may have additional embodiments, and that the technology may be practiced without several of the details of the embodiments described below with reference to FIGS. 1-10.

FIG. 1 is a schematic diagram of an electronic system 100 in accordance with embodiments of the present technology. As shown in FIG. 1, the electronic system 100 can include an input device 102, a detector 104, an output device 106, and a controller 118 operatively coupled to the foregoing components. Optionally, the electronic system 100 can also include an illumination source 112 (e.g., a fluorescent light bulb) configured to provide illumination 114 to the input device 102 and/or other components of the electronic system 100. In other embodiments, the illumination source 112 may be omitted. In further embodiments, the electronic system 100 may also include a television tuner, touch screen controller, telephone circuitry, and/or other suitable components.

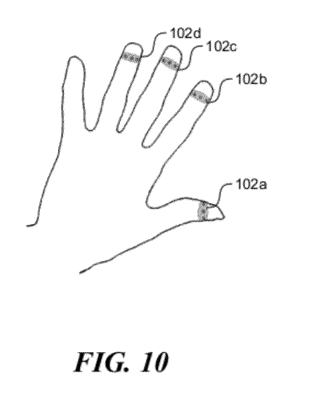

The input device 102 can be configured to be touch free from the output device 106. For example, in the illustrated embodiment, the input device 102 is configured as a ring wearable on an index finger of a user 101. In other examples, the input device 102 may be configured as a ring wearable on other fingers of the user 101. In further examples, the input device 102 may be configured as an open ring, a finger probe, a finger glove, a hand glove, and/or other suitable item for a finger, a hand, and/or other parts of the user 101. Even though only one input device 102 is shown in FIG. 1, in other embodiments, the electronic system 100 may include more than one input device 102, as described in more detail below with reference to FIG. 10.

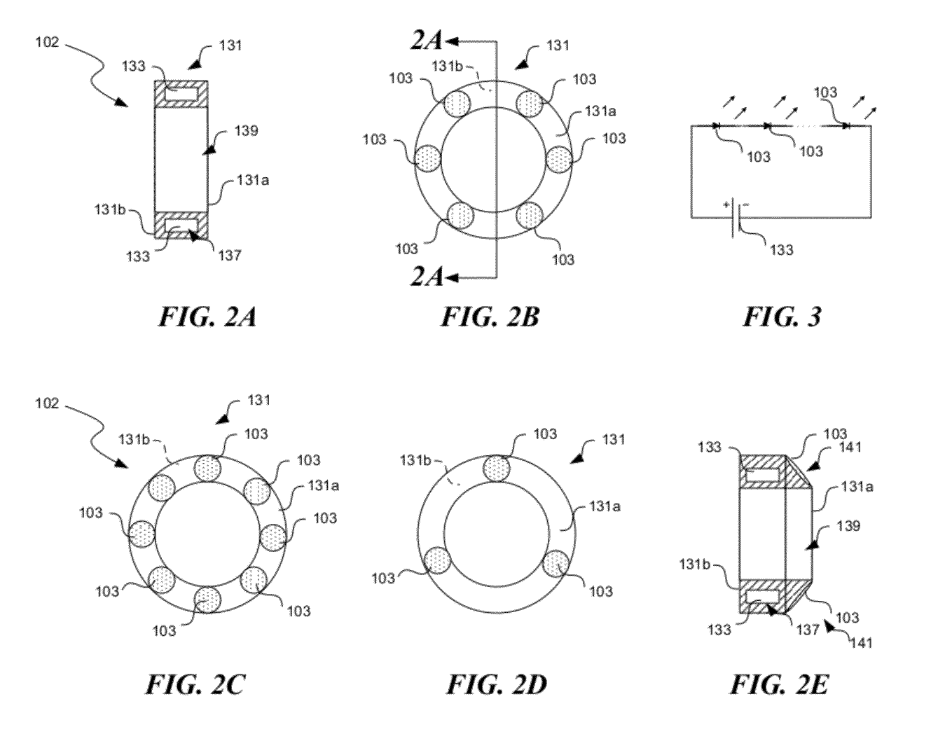

The input device 102 can include at least one marker 103 (only one is shown in FIG. 1 for clarity) configured to emit a signal 110 to the detector 104. In certain embodiments, the marker 103 can be an actively powered component. For example, the marker 103 can include a light emitting diode (“LED”), an organic light emitting diode (“OLED”), a laser diode (“LDs”), a polymer light emitting diode (“PLED”), a fluorescent lamp, an infrared (“IR”) emitter, and/or other suitable light emitter configured to emit a light in the visible, infrared (“IR”), ultraviolet, and/or other suitable spectra. In other examples, the marker 103 can include a radio transmitter configured to emit a radio frequency (“RF”), microwave, and/or other types of suitable electromagnetic signal. In further examples, the marker 103 can include an ultrasound transducer configured to emit an acoustic signal. In yet further examples, the input device 102 can include at least one emission source configured to produce an emission (e.g., light, RF, IR, and/or other suitable types of emission). The marker 103 can include a “window” or other suitable passage that allows at least a portion of the emission to pass through. In any of the foregoing embodiments, the input device 102 can also include a power source (shown in FIG. 2A) coupled to the marker 103 or the at least one emission source. Several examples of an active input device 102 are described in more detail below with reference to FIGS. 2A-3.

In other embodiments, the marker 103 can include a non-powered (i.e., passive) component. For example, the marker 103 can include a reflective material that emits the signal 110 by reflecting at least a portion of the illumination 114 from the optional illumination source 112. The reflective material can include aluminum foils, mirrors, and/or other suitable materials with sufficient reflectivity. In further embodiments, the input device 102 may include a combination of powered and passive components. In any of the foregoing embodiments, one or more markers 103 may be configured to emit the signal 110 with a generally circular, triangular, rectangular, and/or other suitable pattern.

The detector 104 is configured to monitor and capture the signal 110 emitted from the marker 103 of the input device 102. In the following description, a camera (e.g., Webcam C500 provided by Logitech of Fremont, Calif.) for capturing an image and/or video of the input device 102 is used as an example of the detector 104 for illustration purposes. In other embodiments, the detector 104 can also include an IR camera, laser detector, radio receiver, ultrasonic transducer and/or other suitable types of radio, image, and/or sound capturing component. Even though only one detector 104 is shown in FIG. 1, in other embodiments, the electronic system 100 may include two, three, four, or any other suitable number of detectors 104 (not shown).

The output device 106 can be configured to provide textual, graphical, sound, and/or other suitable type of feedback to the user 101. For example, as shown in FIG. 1, the output device 106 may display a computer cursor 108 to the user 101. In the illustrated embodiment, the output device 106 includes a liquid crystal display (“LCD”). In other embodiments, the output device 106 can also include a touch screen, an OLED display, a projected display, and/or other suitable displays.

The controller 118 can include a processor 120 coupled to a memory 122 and an input/output interface 124. The processor 120 can include a microprocessor, a field-programmable gate array, and/or other suitable logic processing component. The memory 122 can include volatile and/or nonvolatile computer readable media (e.g., ROM; RAM, magnetic disk storage media; optical storage media; flash memory devices, EEPROM, and/or other suitable non-transitory storage media) configured to store data received from, as well as instructions for, the processor 120. In one embodiment, both the data and instructions are stored in one computer readable medium. In other embodiments, the data may be stored in one medium (e.g., RAM), and the instructions may be stored in a different medium (e.g., EEPROM). The input/output interface 124 can include a driver for interfacing with a camera, display, touch screen, keyboard, track ball, gauge or dial, and/or other suitable types of input/output devices.

In certain embodiments, the controller 118 can be operatively coupled to the other components of the electronic system 100 via a hardwire communication link (e.g., a USB link, an Ethernet link, an RS232 link, etc.). In other embodiments, the controller 118 can be operatively coupled to the other components of the electronic system 100 via a wireless connection (e.g., a WIFI link, a Bluetooth link, etc.). In further embodiments, the controller 118 can be configured as an application specific integrated circuit, system-on-chip circuit, programmable logic controller, and/or other suitable computing framework.

In certain embodiments, the detector 104, the output device 106, and the controller 118 may be configured as a desktop computer, a laptop computer, a tablet computer, a smart phone, an electronic whiteboard, and/or other suitable types of computing devices. In other embodiments, the output device 106 may be at least a part of a television set. The detector 104 and/or the controller 118 may be integrated into or separate from the television set. In further embodiments, the controller 118 and the detector 104 may be configured as a unitary component (e.g., a game console, a camera, or a projector), and the output device 106 may include a television screen and/or other suitable displays. In additional embodiments, the input device 102, a computer storage medium storing instructions for the processor 120, and associated operational instructions may be configured as a kit. In yet further embodiments, the input device 102, the detector 104, the output device 106, and/or the controller 118 may be independent from one another or may have other suitable configurations.

The user 101 can operate of the controller 118 in a touch free fashion by, for example, swinging, gesturing, and/or otherwise moving his/her finger with the input device 102. The electronic system 100 can monitor the user's finger movements and correlate the movements with computing commands from the user 101. The electronic system 100 can then execute the computing commands by, for example, moving the computer cursor 108 from a first position 109a to a second position 109b. One of ordinary skill in the art will understand that the discussion below is for illustration purposes only. The electronic system 100 can be configured to perform other operations in addition to or in lieu of the operation discussed below.

In operation, the controller 118 can instruct the detector 104 to start monitoring the marker 103 of the input device 102 for commands based on certain preset conditions. For example, in one embodiment, the controller 118 can instruct the detector 104 to start monitoring the signal 110 when the signal 110 emitted from the marker 103 is detected. In another example, the controller 118 can instruct the detector 104 to start monitoring the signal 110 when the controller 118 determines that the signal 110 is relatively stationary for a preset period of time (e.g., 0.1 second). In further example, the controller 118 can instruct the detector 104 to start monitoring the signal 110 based on other suitable conditions.

After the detector 104 starts to monitor the markers 103 on the input device 102, the processor 120 samples a captured image of the input device 102 from the detector 104 via the input/output interface 124. The processor 120 then performs image segmentation by identifying pixels and/or image segments in the captured image corresponding to the emitted signal 110. The identification may be based on pixel intensity and/or other suitable parameters.

The processor 120 then identifies certain characteristics of the segmented image of the input device 102. For example, in one embodiment, the processor 120 can identify a number of observed markers 103 based on the segmented image. The processor 120 can also calculate a distance between individual pairs of markers 103 in the segmented image. In other examples, the processor 120 may also perform shape (e.g., a circle or oval) fitting based on the segmented image and know configuration of the markers 103. In further examples, the processor 120 may perform other suitable analysis on the segmented image.

The processor 120 then retrieves a predetermined pattern of the input device 102 from the memory 122. The predetermined pattern may include orientation and/or position parameters of the input device 102 calculated based on analytical models. For example, the predetermined pattern may include a number of observable markers 103, a distance between individual pairs of markers 103, and/or other parameters based on a known planar angle between the input device 102 and the detector 104. By comparing the identified characteristics of the segmented image and the retrieved predetermined pattern, the processor 120 can determine at least one of the possible orientations and a current distance from the detector of the input device 102.

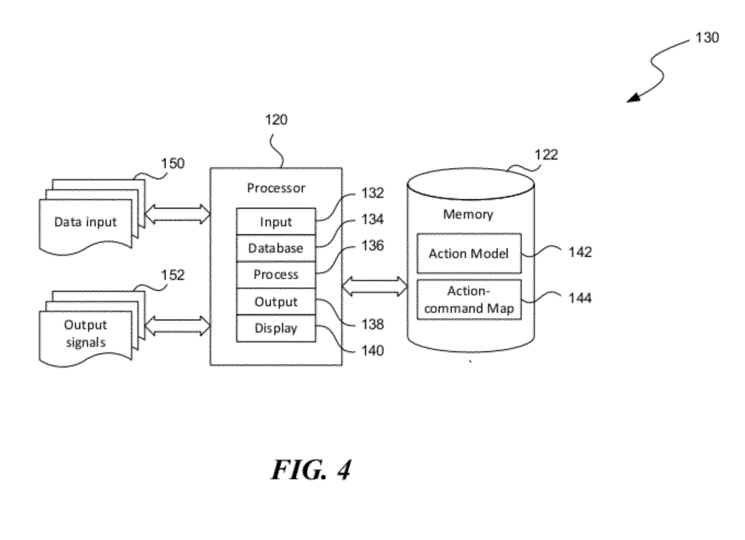

The processor 120 then repeats the foregoing operations for a period of time (e.g., 0.5 seconds) and accumulates the determined orientation and/or distance in a buffer or other suitable computer memory. Based on the accumulated orientation and/or distance at multiple time points, the processor 120 can then construct a temporal trajectory of the input device 102 between. The processor 120 then compares the constructed temporal trajectory to a trajectory action model (FIG. 4) stored in the memory 122 to determine a gesture, movement, and/or other action of the user 101. For example, as shown in FIG. 1, the processor 120 may determine that the constructed trajectory correlates to a generally linear swing of the index finger of the user 101.

Once the user action is determined, the processor 120 can map the determined user action to a control and/or other suitable types of operation. For example, in the illustrated embodiment, the processor 120 may map the generally linear swing of the index figure to a generally linear movement of the computer cursor 108. As a result, the processor 120 outputs a command to the output device 106 to move the computer cursor 108 from the first position 109a to the second position 109b.

Several embodiments of the electronic system 100 can be more intuitive or natural to use than conventional input devices by recognizing and incorporating commonly accepted gestures. For example, left or right shift of the computer cursors 108 can include left or right shift of the index finger of the user 101. Also, several embodiments of the electronic system 100 do not require rigid postures of the user 101 when operating the electronic system 100. Instead, the user 101 may operate the electronic system 100 in any posture comfortable to him/her with the input device 102 on his/her finger. In addition, several embodiments of the electronic system 100 can be more mobile than certain conventional input devices because operating the input device 102 does not require a hard surface or any other support.

FIG. 2A is a side cross-sectional view of an input device 102 suitable for use in the electronic system 100 of FIG. 1 in accordance with embodiments of the present technology. As shown in FIG. 2A, the input device 102 can include a ring 131 with a first side 131a opposite a second side 131b and an aperture 139 extending between the first and second sides 131a and 131b. The aperture 139 may be sized and/or shaped to accommodate a finger of the user 101 (FIG. 1). In the illustrated embodiment, the first and second sides 131a and 131b are generally planar and parallel to each other. In other embodiments, the first and second sides 131a and 131b may have curved surfaces, a beveled or rounded edge, and/or other suitable configurations. In certain embodiments, the input device 102 can include an internal chamber 137 configured to house a battery 133 (e.g., a lithium ion battery). In one embodiment, the battery 133 may be rechargeable and may include a capacitor, switch, and/or other suitable electrical components. The input device 102 may also include a recharging mechanism (not shown) configured to facilitate recharging the battery 133. In other embodiments, the battery 133 may be non-rechargeable. In yet other embodiments, the internal chamber 137 may be omitted, and the input device 102 may include a solar film (not shown) and/or other suitable power sources.

FIG. 2B is a front view of the input device 102 of FIG. 2A in accordance with embodiments of the present technology. As shown in FIG. 2B, the input device 102 can include a plurality of markers 103 (six are shown for illustration purposes) proximate the first side 131a of the ring 131. The markers 103 may be secured to the ring 131 with clamps, clips, pins, retaining rings, Velcro, adhesives, and/or other suitable fasteners, or may be pressure and/or friction fitted in the ring 131 without fasteners.

In other embodiments, the input device 102 may include more or fewer markers 103 with other suitable arrangements, as shown in FIGS. 2C and 2D, respectively. In yet further embodiments, the input device 102 can have other suitable number of markers 103 and/or other suitable arrangements thereof. Even though the markers 103 are shown in FIGS. 2A-2D as being separate from one another, in additional embodiments, the markers 103 may be arranged in a side-by-side, overlapped, superimposed and/or other suitable arrangements to form a band, stripe, belt, arch, and/or other suitable shape.

FIG. 2E is a side cross-sectional view of an input device 102 with beveled surfaces in accordance with embodiments of the present technology. As shown in FIG. 2E, the input device 102 can include generally similar components as that described above with reference to FIG. 2A except that the markers 103 are positioned in and/or on beveled surfaces 141. In the illustrated embodiment, the beveled surfaces 141 are generally planar. In other embodiments, the beveled surfaces 141 may be curved or may have other suitable arrangements.

FIG. 3 is an electrical circuit diagram suitable for the input device 102 discussed above with reference to FIGS. 2A-2E. As shown in FIG. 3, in the illustrated embodiment, the markers 103 are shown as LEDs connected in series in an LED chain, and the battery 133 is coupled to both ends of the LED chain. In other embodiments, the markers 103 may be coupled to one another in parallel or in other suitable fashion. Even though not shown in FIG. 3, the input device 102 may also include switches, power controllers, and/or other suitable electrical/mechanical components for powering the markers 103.

FIG. 4 is a block diagram showing computing system software modules 130 suitable for the controller 118 in FIG. 1 in accordance with embodiments of the present technology. Each component may be a computer program, procedure, or process written as source code in a conventional programming language, such as the C++ programming language, or other computer code, and may be presented for execution by the processor 120 of the controller 118. The various implementations of the source code and object byte codes may be stored in the memory 122. The software modules 130 of the controller 118 may include an input module 132, a database module 134, a process module 136, an output module 138 and a display module 140 interconnected with one another.

In operation, the input module 132 can accept data input 150 (e.g., images from the detector 104 in FIG. 1), and communicates the accepted data to other components for further processing. The database module 134 organizes records, including an action model 142 and an action-command map 144, and facilitates storing and retrieving of these records to and from the memory 122. Any type of database organization may be utilized, including a flat file system, hierarchical database, relational database, or distributed database, such as provided by a database vendor such as the Oracle Corporation, Redwood Shores, Calif.

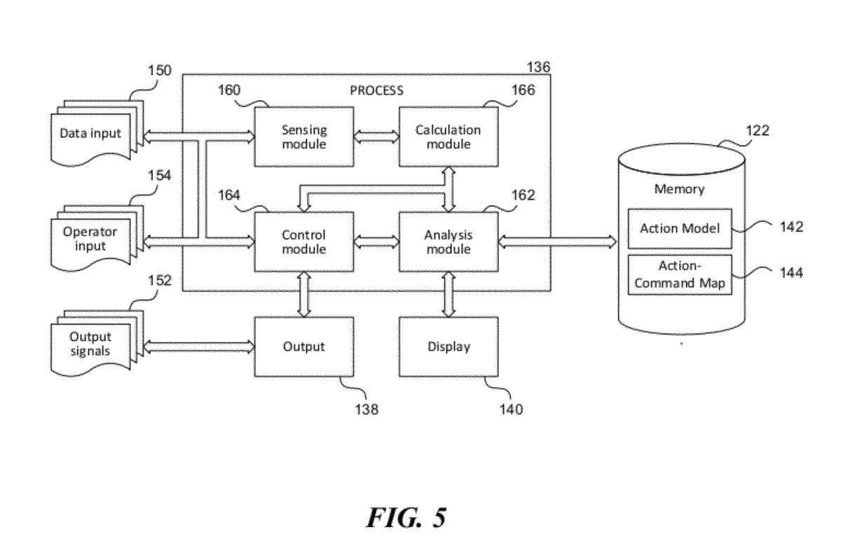

The process module 136 analyzes data input 150 from the input module 132 and/or other data sources, and the output module 138 generates output signals 152 based on the analyzed data input 150. The processor 120 may include the display module 140 for displaying, printing, or downloading the data input 150, the output signals 152, and/or other information via the output device 106 (FIG. 1), a monitor, printer, and/or other suitable devices. Embodiments of the process module 136 are described in more detail below with reference to FIG. 5.

FIG. 5 is a block diagram showing embodiments of the process module 136 of FIG. 4. As shown in FIG. 5, the process module 136 may further include a sensing module 160, an analysis module 162, a control module 164, and a calculation module 166 interconnected with one other. Each module may be a computer program, procedure, or routine written as source code in a conventional programming language, or one or more modules may be hardware modules.

The sensing module 160 is configured to receive the data input 150 and identify the marker 103 (FIG. 1) of the input device 102 (FIG. 1) based thereon (referred to herein as “image segmentation”). For example, in certain embodiments, the data input 150 includes a still image (or a video frame) of the input device 102, the user 101 (FIG. 1), and background objects (not shown). The sensing module 160 can then be configured to identify segmented pixels and/or image segments in the still image that correspond to the markers 103 of the input device 102. Based on the identified pixels and/or image segments, the sensing module 160 forms a segmented image of the markers 103 of the input device 102.

In one embodiment, the sensing module 160 includes a comparison routine that compares light intensity values of the individual pixels with a preset threshold. If a light intensity is above the preset threshold, the sensing module 160 can indicate that the pixel corresponds to one of the markers 103. In another embodiment, the sensing module 160 may include a shape determining routine configured to approximate or identify a shape of the segmented pixels in the still image. If the approximated or identified shape matches a preset shape of the markers 103, the sensing module 160 can indicate that the pixels correspond to the markers 103.

In yet another embodiment, the sensing module 160 can include a filtering routine configured to identify pixels with a particular color index, peak frequency, average frequency, and/or other suitable spectral characteristics. If the filtered spectral characteristics match a preset value of the markers 103, the sensing module 160 can indicate that the pixels correspond to the markers 103. In further embodiments, the sensing module 160 may include a combination of at least some of the comparison routine, the shape determining routine, the filtering routine, and/or other suitable routines.

The calculation module 166 may include routines configured to perform various types of calculations to facilitate operation of other modules. For example, the calculation module 166 can include a sampling routine configured to sample the data input 150 at regular time intervals along preset directions. In certain embodiments, the sampling routine can include linear or non-linear interpolation, extrapolation, and/or other suitable subroutines configured to generate a set of data, images, frames from the detector 104 (FIG. 1) at regular time intervals (e.g., 30 frames per second) along x-, y-, and/or z-direction. In other embodiments, the sampling routine may be omitted.

The calculation module 166 can also include a modeling routine configured to determine an orientation of the input device 102 relative to the detector 104. In certain embodiments, the modeling routine can include subroutines configured to determine and/or calculate parameters of the segmented image. For example, the modeling routine may include subroutines to determine a quantity of markers 103 in the segmented image. In another example, the modeling routine may also include subroutines that calculate a distance between individual pairs of the markers 103.

In another example, the calculation module 166 can also include a trajectory routine configured to form a temporal trajectory of the input device 102. In one embodiment, the calculation module 166 is configured to calculate a vector representing a movement of the input device 102 from a first position/orientation at a first time point to a second position/orientation at a second time point. In another embodiment, the calculation module 166 is configured to calculate a vector array or plot a trajectory of the input device 102 based on multiple position/orientation at various time points. In other embodiments, the calculation module 166 can include linear regression, polynomial regression, interpolation, extrapolation, and/or other suitable subroutines to derive a formula and/or other suitable representation of movements of the input device 102. In yet other embodiments, the calculation module 166 can include routines to compute a travel distance, travel direction, velocity profile, and/or other suitable characteristics of the temporal trajectory. In further embodiments, the calculation module 166 can also include counters, timers, and/or other suitable routines to facilitate operation of other modules.

The analysis module 162 can be configured to analyze the calculated temporal trajectory of the input device 102 to determine a corresponding user action or gesture. In certain embodiments, the analysis module 162 analyzes characteristics of the calculated temporal trajectory and compares the characteristics to the action model 142. For example, in one embodiment, the analysis module 162 can compare a travel distance, travel direction, velocity profile, and/or other suitable characteristics of the temporal trajectory to known actions or gesture in the action model 142. If a match is found, the analysis module 166 is configured to indicate the identified particular user action or gesture.

The analysis module 162 can also be configured to correlate the identified user action or gesture to a control action based on the action-command map 144. For example, if the identified user action is a lateral move from left to right, the analysis module 162 may correlate the action to a lateral cursor shift from left to right, as shown in FIG. 1. In other embodiments, the analysis module 162 may correlate various user actions or gestures with any suitable commands and/or data input.

The control module 164 may be configured to control the operation of the controller 118 (FIG. 1) based on the command and/or data input identified by the analysis module 162. For example, in one embodiment, the control module 164 may include an application programming interface (“API”) controller for interfacing with an operating system and/or application program of the controller 118. In other embodiments, the control module 164 may include a feedback routine (e.g., a proportional-integral or proportional-integral-differential routine) that generates one of the output signals 152 (e.g., a control signal of cursor movement) to the output module 138 based on the identified command and/or data input. In further example, the control module 164 may perform other suitable control operations based on operator input 154 and/or other suitable input. The display module 140 may then receive the determined commands and generate corresponding output to the user 101 (FIG. 1).

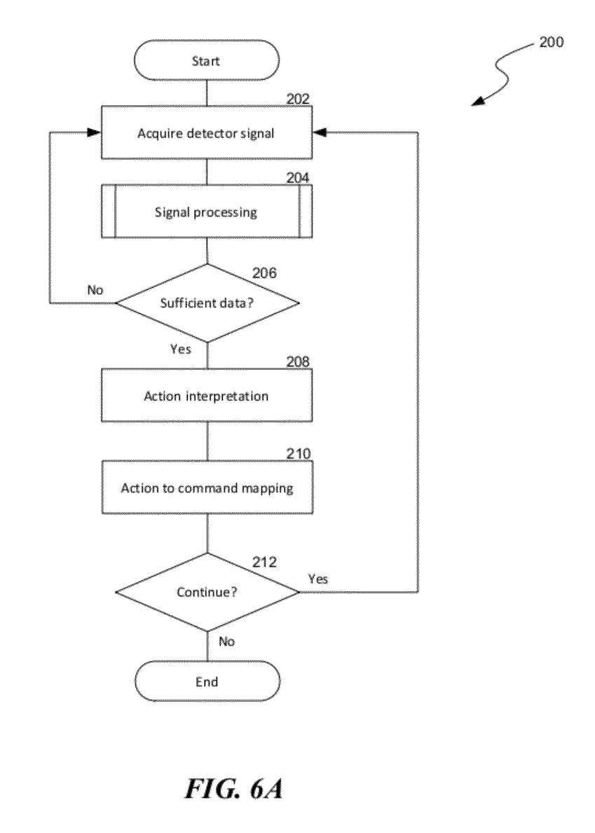

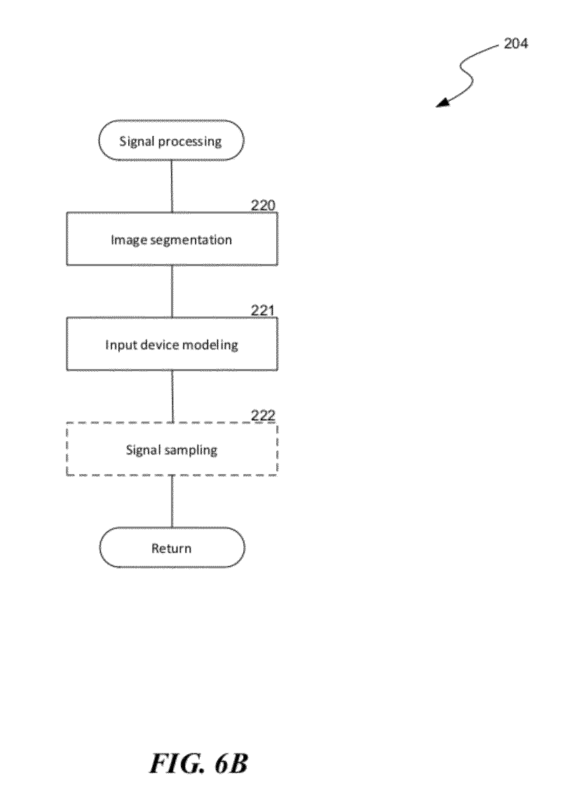

FIG. 6A is a flowchart showing a method 200 for touch free operation of an electronic system in accordance with embodiments of the present technology. Even though the method 200 is described below with reference to the electronic system 100 of FIG. 1 and the software modules of FIGS. 4 and 5, the method 200 may also be applied in other systems with additional and/or different hardware/software components.

As shown in FIG. 6A, one stage 202 of the method 200 includes acquiring data input from the detector 104 (FIG. 1). In one embodiment, acquiring data input includes capturing frames of images of the input device 102 (FIG. 1) in a background. Each frame may include a plurality of pixels (e.g., 1280×1024) in two-dimension. In other embodiments, acquiring input data can include acquiring a radio, laser, ultrasound, and/or other suitable types of signal.

Another stage 204 of the method 200 includes processing the acquired input data to identify a temporal trajectory of the input device 102. In one embodiment, the identified temporal trajectory includes a vector representing a movement of the input device 102. In other embodiments, the identified temporal trajectory includes a vector array that describes position and orientation of the input device 102 at different time moments. In further embodiments, the identified movement can include other suitable representations of the input device 102. Certain embodiments of processing the acquired input data are described in more detail below with reference to FIG. 6B.

The method 200 then includes a decision stage 206 to determine if sufficient data are available. In one embodiment, sufficient data are indicated if the processed input data exceed a preset threshold. In another embodiment, sufficient data are indicated after a preset period of time (e.g., 0.5 seconds) has elapsed. In further embodiments, sufficient data may be indicated based on other suitable criteria. If sufficient data are not indicated, the process reverts to acquiring detector signal at stage 202; otherwise, the process proceeds to interpreting user action based on the identified temporal trajectory of the input device 102 at stage 208.

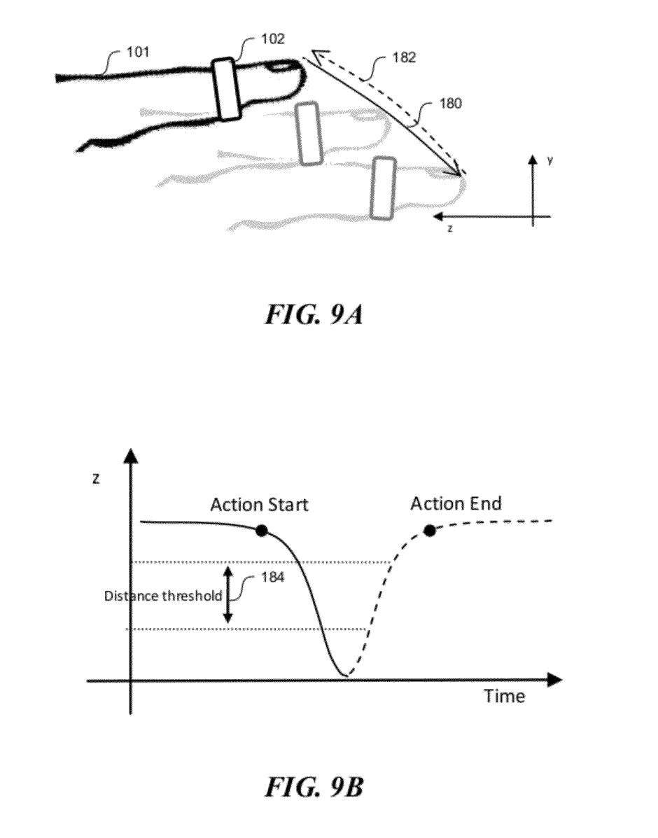

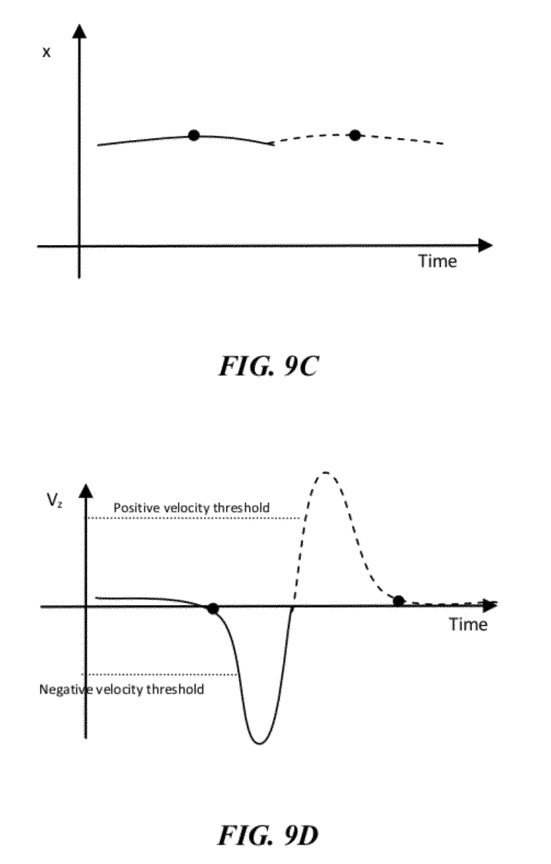

In certain embodiments, interpreting user action includes analyzing and comparing characteristics of the temporal trajectory with known user actions. For example, a position, position change, lateral movement, vertical movement, movement velocity, and/or other characteristics of the temporal trajectory may be calculated and compared with a predetermined action model. Based on the comparison, a user action may be indicated if characteristics of the temporal trajectory match those in the action model. An example of interpreting user action is described in more detail below with reference to FIGS. 9A-9D.

The method 200 further includes another stage 210 in which the identified user action is mapped to a command. The method 200 then includes a decision stage 212 to determine if the process should continue. In one embodiment, the process is continued if further movement of the input device 102 is detected. In other embodiments, the process may be continued based on other suitable criteria. If the process is continued, the process reverts to acquiring sensor readings at stage 202; otherwise, the process ends.

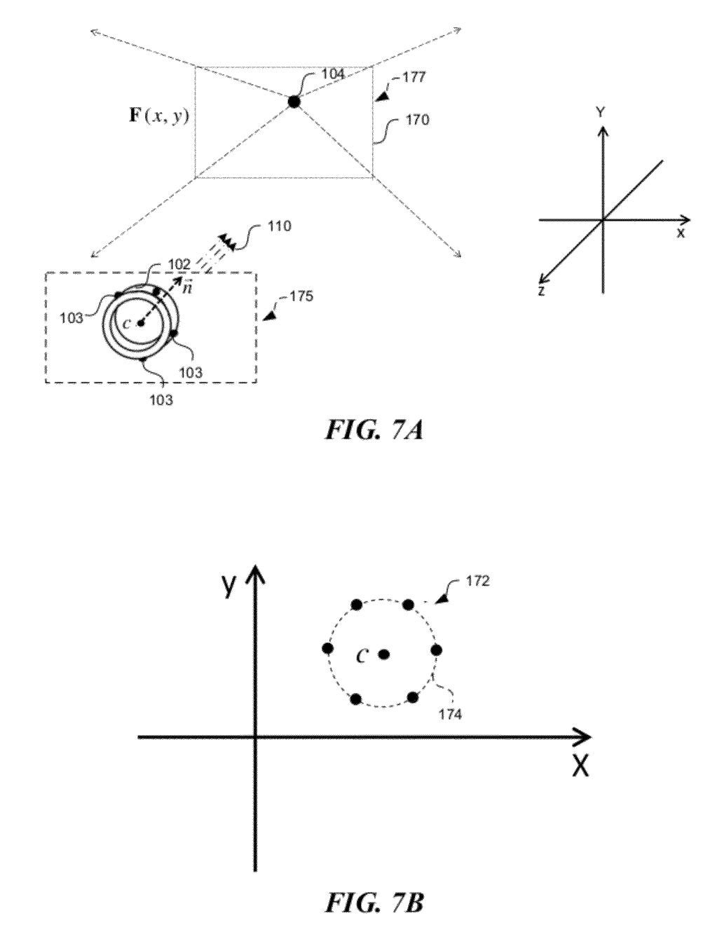

FIG. 6B a flowchart showing a signal processing method 204 suitable for the method 200 of FIG. 6A in accordance with embodiments of the present technology. As shown in FIG. 6B, one stage 220 of the method 204 includes image segmentation of the acquired detector signal to identify pixels and/or image segments corresponding to the marker 103 (FIG. 1). Techniques for identifying such pixels are described above with reference to FIG. 5. An example of image segmentation is described in more detail below with reference to FIGS. 7A-7B.

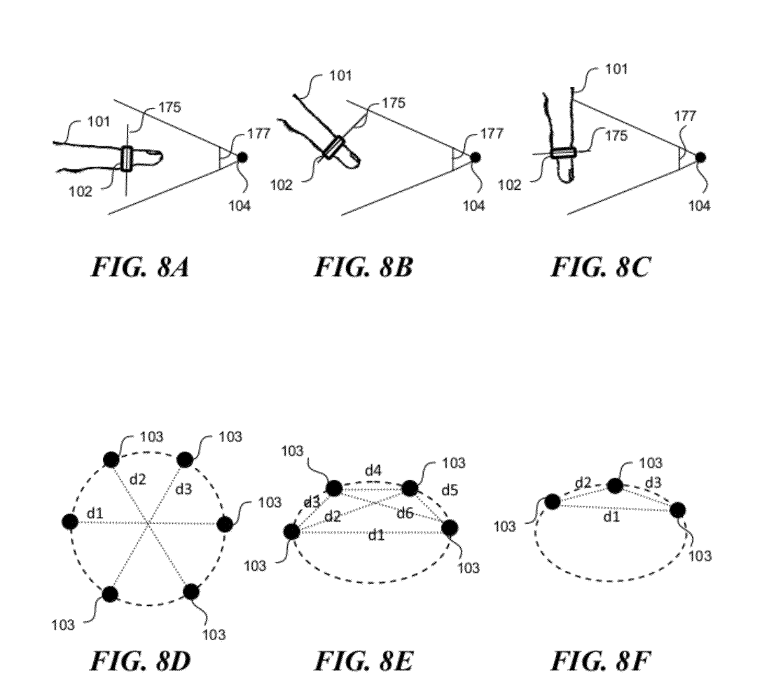

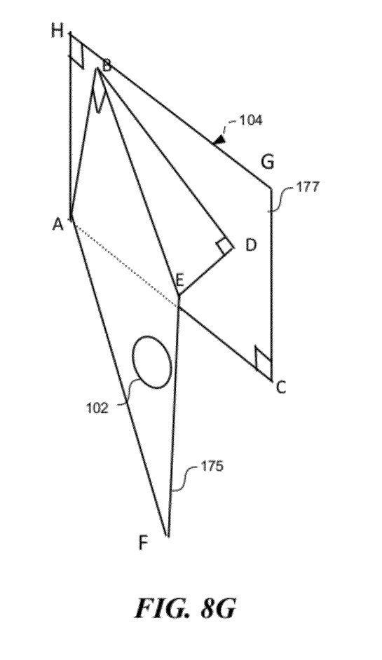

Another stage 221 of the method 204 includes modeling the segmented image to determine at least one of an orientation and position of the input device 102 (FIG. 1) relative to the detector 104 (FIG. 1). In one embodiment, input device modeling includes identifying and comparing characteristics of the segmented image to a predetermined input device model. Such characteristics can include a quantity of markers 103, distance between individual pairs of the markers 103, and/or other suitable characteristics. In further embodiments, input device modeling can include a combination of the foregoing techniques and/or other suitable techniques. Based on the comparison between the identified characteristics of the segmented image and those of the action model, a temporal trajectory (i.e., an orientation and/or position) of the input device 102 may be determined. An example of input device modeling is described in more detail below with reference to FIGS. 8A-8G.

Optionally, the process can also include signal sampling at stage 222. In one embodiment, the models (e.g., position and/or orientation) of the input device 102 generated based on the acquired input data are sampled at regular time intervals along x-, y-, or z-direction by applying linear interpolation, extrapolation, and/or other suitable techniques. In other embodiments, the image model of the acquired detector signal is sampled at other suitable time intervals. In further embodiments, the image sampling stage 222 may be omitted. After the optional signal sampling, the process returns to the method 200 of FIG. 6A.

FIGS. 7A-9D schematically illustrate certain aspects of the method 200 described above with reference to FIGS. 6A and 6B. FIG. 7A is a schematic spatial diagram showing an input device 102 and a detector 104 in accordance with embodiments of the present technology. As shown in FIG. 7A, the detector 104 has a two-dimensional viewing area 170, and the input device 102 includes markers 103 with a center C and a normal vector \vec{n}, which defines a input device plane 175 with respect to a detector plane 177. As discussed above, the markers 103 emit a signal 110 toward the detector 104. In response, the detector 104 acquires an image frame F(x, y) of the input device 102.

The acquired image of the input device 102 at time tᵢ, is then segmented to identify pixels or image segments P^{t}^{ᵢ}={(xⱼ, yⱼ), j=1 . . . m} corresponding to the markers 103. FIG. 7B is a schematic diagram illustrating a segmented image of the input device 102. As shown in FIG. 7B, the segmented image 172 of the markers 103 (FIG. 7A) may be used to model the projection of the input device 102 (FIG. 7A) as an ellipse 174 (shown in phantom lines for clarity) and characteristics (e.g., a number of markers 103) may be identified based thereon.

FIGS. 8A-8G illustrate one example technique of image modeling for determining an orientation and/or position of an input device 102 relative to a detector 104. In the following discussion, the input device 102 with six markers 103 shown in FIG. 2A is used for illustration purposes only. FIGS. 8A-8C schematically illustrate three relative orientations between the input device 102 and the detector 104 in accordance with embodiments of the technology. As shown in FIGS. 8A-8C, the input device 102 has an input plane 175, and the detector 104 has a detector plane 177. FIG. 8A shows the input plane 175 generally parallel to the detector plane 177. FIG. 8B shows the input plane 175 canted relative to the detector plane 177. FIG. 8C shows the input plane 175 generally perpendicular to the detector plane 177.

FIGS. 8D-8F schematically illustrate segmented images of the input device in FIGS. 8A-8C, respectively. The different orientations may cause different number of markers 103 to be visible to the detector 104. For example, as shown in FIG. 8D, all six markers 103 are visible in the segmented image when the input plane 175 is generally parallel to the detector plane 177. As shown in FIG. 8E, four markers 103 are visible in the segmented image when the input plane 175 is canted to the detector plane 177. As shown in FIG. 8F, three markers 103 are visible in the segmented image when the input plane 175 is generally perpendicular to the detector plane 177. In one embodiment, at least some of the pairwise distances d1, d2, d3, . . . , d6 may be calculated depending on the number of visible markers 103, as shown in FIGS. 8D-8F. In other embodiments, all possible pairwise distances may be calculated irrespective of the number of visible markers 103.

FIG. 8G schematically illustrates the input plane 175 relative to the detector plane 177 in accordance with embodiments of the technology. As shown in FIG. 8G, the input plane 175 is defined by points ABEF, and the detector plane is defined by points AHGC. Without being bound by theory, it is believed that the orientation of the input plane 175 relative to the detector plane 177 can be specified by a first angle EBD and a second angle BAC. It is believed that for possible values of angles (EBD) and (BAC) from set A={α₁, . . . , αₙ:α₁=0 and αₙ=π and aᵢ<αᵢ+1} corresponding projections of the markers 103 may be calculated based on known geometry of the input device 102 and the placement of the markers 103. As a result, for instance, for each combination of angles (EBD) and (BAC), a set of corresponding pairwise distances of the markers 103 may be calculated and stored in the memory 122 (FIG. 4).

As described above with reference to FIGS. 6A and 6B, the calculated pairwise distances from the segmented image may then be compared to the angles in set A and corresponding predetermined pairwise distances. Based on the comparison, angles (EBD) and (BAC) may be estimated as the elements of set A that substantially match the calculated pairwise distances from the segmented image. In certain embodiments, both the calculated and predetermined pairwise distances can be normalized to, for example, the largest pairwise distance. In other embodiments, such normalization may be omitted. Once the orientation of the input plane 175 is determined, the distance of the input device 102 (e.g., from its center) to the detector 104 may be estimated as

B=D*bi/di

where bi is an observed distance between two marker projections; D is the predetermined distance between the center of the input device 102 and the detector 104; and di is a predetermined distance between two marker projections.

The foregoing operations can be repeated to form a temporal trajectory that can be interpreted as certain command and/or data input. FIGS. 9A-9D schematically show one example of identifying and correlating a user action to a command in accordance with embodiments of the present technology. As shown in FIG. 9A, the movement of the input device 102 includes a forward trajectory 180 and a backward trajectory 182 generally in the y-z plane. As shown in FIG. 9B, a first characteristic of the temporal trajectory in FIG. 9A is that both the forward and backward trajectories have a travel distance that exceeds a distance threshold 184. Also, as shown in FIG. 9C, a second characteristic of the temporal trajectory in FIG. 9A is that the distance along the x-axis is below a preset threshold, indicating relatively negligible movement along the x-axis. In addition, as shown in FIG. 9D, a third characteristic of the temporal trajectory in FIG. 9A is that the velocity of the center of the input device 102 (FIG. 9A) exceeds a preset negative velocity threshold when moving toward the detector 104 (FIG. 9A) and exceeds a positive velocity threshold when moving away from the detector 104.

In one embodiment, if all of the first, second, and third characteristics of the temporal trajectory are identified, the user action may be recognized as a click, a selection, a double click, and/or other suitable commands. In other embodiments, only some of the first, second, and third characteristics may be used to correlate to a command. In further embodiments, at least one of these characteristics may be used in combination with other suitable characteristics to correlate to a command.

Even though the electronic system 100 in FIG. 1 is described above to include one input device 102, in other embodiments, the electronic system 100 may include multiple markers 102. For example, FIG. 10 is a top view of a user's hand with multiple markers 102 in accordance with embodiments of the present technology. In the illustrated embodiment, four markers 102 (identified individually as first, second, third, and fourth input device 102a-102d, respectively) are shown for illustration purposes. In certain embodiments, the markers 102 may have different size, shape, and/or component from one another. In other embodiments, the markers 102 may all be generally identical. In further embodiments, the electronic system 100 can include any other suitable number of markers 102.

The individual markers 102 may operate independently from one another or may be used in combination to provide command to the electronic system 100. For example, in one embodiment, the electronic system 100 may recognize that the first and second markers 102a and 102b are joined together in a closing gesture. In response, the electronic system 100 may correlate the closing gesture to a command to close a program, to a click, or to other suitable operations. In other embodiments, the individual markers 102 may have corresponding designated functions. For example, the electronic system 100 may recognize movements of only the second input device 102b as cursor shift. In further embodiments, the markers 102 may operate in other suitable fashions. In yet further embodiments, the user 101 (FIG. 1) may use both hands with one or more markers 102 to operate the electronic system 100.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/we claim:

1. A computer-implemented method, comprising:
acquiring images of an input device with a camera, the input device being on a finger of a user and having a plurality of markers;
identifying segments in the individual acquired images, the identified segments corresponding to the markers;
forming a temporal trajectory of the input device based on the identified segments in the individual acquired images;
correlating the formed temporal trajectory with a computing command; and
executing the computing command by a processor.

2. The method of claim 1 wherein acquiring images of the input device includes acquiring a plurality of frames of the input device with a camera coupled to the processor.

3. The method of claim 1 wherein identifying segments includes:
comparing an intensity value of a pixel of the individual acquired images to a preset threshold; and
if the intensity value of the pixel is greater than the preset threshold, indicating the pixel corresponds to one of the markers.

4. The method of claim 1 wherein identifying segments includes:
comparing a shape and/or a size range of segmented pixels in the individual acquired images to a preset shape and/or size range, respectively; and
if the shape and/or size range of the segmented pixels generally matches the preset shape and/or size range, respectively, indicating the pixels corresponds to the markers.

5. The method of claim 1, further comprising, for each of the acquired images, analyzing the identified segments to determine an orientation of the input device based on a dimension of the input device and an arrangement of the markers on the input device.

6. The method of claim 1, further comprising, for each of the acquired images:
calculating a pairwise distance for individual pairs of markers in the acquired image;
performing a comparison of the calculated pairwise distance with predetermined pairwise distances based on a dimension of the input device, an arrangement of the markers on the input device, and possible orientations of the input device relative to the camera; and
determining an orientation of the input device relative to the camera based on the comparison.

7. The method of claim 6, further comprising calculating a distance of the input device from the camera based on the determined orientation of the input device.

8. The method of claim 1, further comprising:
identifying a number of visible markers in acquired images based on the identified segments in the acquired image; and
calculating the pairwise distance includes calculating a pairwise distance for individual pairs of visible markers in the acquired image based on the identified number of visible markers.

9. The method of claim 1, wherein forming the temporal trajectory includes identifying an orientation and position of the input device over time, and the method further includes identifying a user action based on characteristics of the temporal trajectory.

10. The method of claim 1, wherein forming the temporal trajectory includes identifying an orientation and position of the input device over time, and the method further includes identifying a user action based on characteristics of the temporal trajectory, the characteristics including at least one of a travel distance, travel direction, velocity, speed, and direction reversal.

11. The method of claim 1 wherein:
the input device is a first input device on a first finger of the user;
the identified segments are first identified segments;
the formed temporal trajectory is a first temporal trajectory;
acquiring images includes:
acquiring images of the first input device and a second input device with the camera, the second input device being on a second finger of the user, the second finger being different than the first finger;
the method further includes:
identifying second segments in the individual images, the identified segments corresponding to the markers of the second input device;
forming a second temporal trajectory based on the second identified segments; and
correlating the formed temporal trajectory includes correlating a combination of the first and second temporal trajectories to the computing command.

12. An electronic system, comprising:
a detector configured to detect an input device having a plurality of markers individually configured to emit a signal to form a signal pattern; and
a controller operatively coupled to the detector, the controller having a computer-readable storage medium containing instructions for performing a method comprising:
receiving input data from the detector, the input data indicating the detected signal pattern from the markers;
analyzing the signal pattern to identify at least one of an orientation and position of the input device relative to the detector based on a dimension of the input device and an arrangement of the markers;
identifying a computing command based at least in part on at least one of the identified orientation and position of the input device relative to the detector; and
executing the computing command with the processor.

13. The electronic system of claim 12, further comprising the input device having the plurality of markers.

14. The electronic system of claim 12 wherein the signal pattern includes a plurality of discrete signals, and wherein analyzing the signal pattern includes identifying a number of visible markers in the received input data based on a number of discrete signals.

15. The electronic system of claim 12 wherein:
the signal pattern includes a plurality of discrete signals;
analyzing the signal pattern includes:
identifying a number of visible markers in the received input data based on a number of discrete signals; and
calculating a pairwise distance for individual pairs of visible markers in the acquired image.

16. The electronic system of claim 15 wherein analyzing the signal pattern also includes:
performing a comparison of the calculated pairwise distance with predetermined pairwise distances based on a dimension of the input device, an arrangement of the markers on the input device, and possible orientations of the input device relative to the detector; and
determining an orientation of the input device relative to the detector based on the comparison.

17. The electronic system of claim 12 wherein identifying the computing command further includes:
repeating the receiving and analyzing operations to obtain at least one of an orientation and position of the input device relative to the detector as a function of time; and
correlating the at least one of an orientation and position of the input device relative to the detector as a function of time with the computing command.

18. The electronic system of claim 12 wherein identifying the computing command further includes:
repeating the receiving and analyzing operations to obtain at least one of an orientation and position of the input device relative to the detector as a function of time;
determining at least one of a travel distance, travel direction, velocity, speed, and direction reversal of the input device based on the at least one of an orientation and position of the input device relative to the detector as a function of time; and
correlating the determined at least one of a travel distance, travel direction, velocity, speed, and direction reversal with the computing command.

19. A computing system, comprising:
an input module configured to acquire images of an input device from a camera, the input device having a plurality of markers;
a sensing module configured to identify segments in the individual acquired images, the identified segments corresponding to the markers;
a calculation module configured to form a temporal trajectory of the input device based on the identified segments in the individual acquired images; and
an analysis module configured to correlate the formed temporal trajectory with a computing command.

20. The computing system of claim 19 wherein the sensing module is configured to:
compare an intensity value of a pixel of the individual acquired images to a preset threshold; and
if the intensity value of the pixel is greater than the preset threshold, indicate the pixel corresponds to one of the markers.

21. The computing system of claim 19 wherein the sensing module is configured to:
compare a shape of pixels in the individual acquired images to a preset shape; and
if the shape of the pixels generally matches the preset shape, indicate the pixels corresponds to the markers.

22. The computing system of claim 19 wherein the calculation module is also configured to determine an orientation of the input device based on a dimension of the input device and an arrangement of the markers on the input device.

23. The computing system of claim 19 wherein the calculation module is also configured to:
calculate a pairwise distance for individual pairs of markers in the acquired image;
perform a comparison of the calculated pairwise distance with predetermined pairwise distances based on a dimension of the input device, an arrangement of the markers on the input device, and possible orientations of the input device relative to the camera; and
determine an orientation of the input device relative to the camera based on the comparison.

24. The computing system of claim 23 wherein the calculation module is also configured to calculate a distance of the input device from the camera based on the determined orientation of the input device.

25. The computing system of claim 19 wherein the calculation module is also configured to:
identify a number of visible markers in acquired images based on the identified segments in the acquired image; and
calculate a pairwise distance for individual pairs of visible markers in the acquired image based on the identified number of visible markers.

26. The computing system of claim 19 wherein the calculation module is also configured to identify temporal trajectory of the input device, and wherein the analysis module is also configured to identify a user action based on characteristics of the temporal trajectory, the characteristics including at least one of a travel distance, travel direction, velocity, speed, and direction reversal.

27. A kit, comprising:
a ring having a plurality of light emitting diodes (LEDs) individually configured to emit a light to form a pattern; and
a computer-readable storage medium containing instructions, when executed by a processor, causing the processor to perform a method comprising:
receiving images of the ring from a camera coupled to the processor;
identifying segments in the individual images, the identified segments corresponding to the LEDs;
analyzing the identified segments to identify at least one of an orientation and position of the ring relative to the camera based on a dimension of the ring and an arrangement of the LEDs;
forming a temporal trajectory of the ring based on the identified segments in the individual acquired images;
correlating the temporal trajectory with a control command; and
supplying the correlated control command to an operating system of the processor.

28. The kit of claim 27 wherein the ring includes an internal chamber and a battery in the internal chamber, and wherein the battery is electrically coupled to the LEDs.

29. The kit of claim 27 wherein:
the ring includes a first side, a second side, and an aperture extending between the first and second sides;
the first side is generally parallel to the second side; and
the LEDs are located proximate the first side.

30. The kit of claim 27 wherein:
the ring includes a first side, a second side, and an aperture extending between the first and second sides;
the first side is generally parallel to the second side;
the ring also includes a beveled surface between the first and second sides; and
at least one of the LEDs is located on the beveled surface.
